(19) United States
(12) Patent Application Publication
(10) Pub. No.: US 2011/0296471 A1
(43) Pub. Date: Dec. 1, 2011

(54) Method for storing and transmitting audio data in an audio and video data stream

(75) Inventor: Dieter NAU, Wetzlar (DE)

(73) Assignee: Continental Automotive GmbH, Hannover (DE)

(21) Appl. No.: 13/019,824

(22) Filed: Feb. 2, 2011

(30) Foreign Application Priority Data
Feb. 9, 2010 (DE) 10 2010 007 258.3

(51) Int. Cl. H04N 7/18

(52) U.S. Cl. 725/75

(57) ABSTRACT

A method for storing and transmitting audio data in an audio and video data stream. Audio and video data is received by a television reception apparatus. At least part of the received audio and video data is transmitted to a processing and storage apparatus. Audio data is extracted from the transmitted audio and video data by the processing and storage apparatus, and the extracted audio data is stored on a storage medium of the processing and storage apparatus. The stored audio data is provided in a motor vehicle information and entertainment system.

### BACKGROUND OF THE INVENTION

1. Field of the Invention

The invention relates to a method for storing and transmitting audio data in an audio and video data stream.

2. Description of the Related Art

DE 10 2004 027 412 A1 discloses a method for transferring text, audio and/or video data from a vehicle communication system to another communication system, for example a DVD player. This method involves the data to be transferred being transferred from one communication system to a memory in a motor vehicle key, and said memory then transferring the buffer-stored data to the other communication system, so that these transferred data can be reproduced in the other communication system. This method can be used to transfer text, audio and/or video data to the vehicle communication system without an additional transfer element.

The known method allows the data transfer, particularly from a non-automotive communication system, for example a DVD player or a home PC, to the motor vehicle key, to comprise large volumes of data. In addition, there are situations in which the desired data cannot be provided easily. By way of example, television programs which are of interest to a television viewer are frequently transmitted in a late-night program. It may then occur that the television viewer becomes tired in the course of the broadcast and wants to go to bed. On the other hand, he would also very much like to follow the broadcast through to the end. The known method is not easily suited to doing this.

### SUMMARY OF THE INVENTION

It is an object of one embodiment of the invention to specify a method for storing and transmitting audio data in an audio and video data stream that allows a television broadcast, particularly a remaining portion of a television broadcast, to be followed to the end as soon and conveniently as possible, the method also requiring as little memory space as possible.

One embodiment of the invention provides a method for storing and transmitting audio data in an audio and video data stream, wherein the method has the following steps: audio and video data are received by a television reception apparatus. In addition, at least portions of the received audio and video data are transmitted to a processing and storage apparatus. Furthermore, the audio data are extracted from the transmitted audio and video data by the processing and storage apparatus, and the extracted audio data are stored on at least one storage medium of the processing and storage apparatus. Additionally, the stored audio data are provided in at least one motor vehicle information and entertainment system.

The method according to the invention advantageously allows the audio data from television programs to be provided fully or in part in the motor vehicle information and entertainment system, and therefore allows the television programs to be followed through to the end. In this case, the method according to one embodiment of the invention has a relatively low memory space requirement on account of the audio data being extracted from the transmitted audio and video data and just the extracted audio data being stored.

In this context, one embodiment of the invention is based on a consideration that many television programs do not require the broadcast actually to be seen, since the actual information comprises spoken words. This is the case with discussion forums, for example. In this case, it is sufficient to follow the audio data in order to obtain almost all the information. It is therefore possible to follow the broadcast during a journey in a motor vehicle by listening to the audio data. In particular, it is possible to follow a broadcast which is being viewed only in part through to the end, this being able to be done at an earlier time than on the home television set, for example on the way to work if this distance is covered in the motor vehicle. At this earlier time after the interruption in the viewing of the original television program, the viewer still largely has the content of the broadcast followed up to the interruption available, which means that it is possible to ensure that the broadcast is followed through to the end without any noticeable loss of information.

In this case, the at least one storage medium is preferably rewriteable. This means that the memory space required for storing the extracted audio data can be made available again after the broadcast has been followed, particularly followed through to the end, by listening to the audio data.

In one embodiment, the at least one storage medium contains or is configured as a hard disk an EEPROM, or particularly a flash memory.

The processing and storage apparatus may be part of a home entertainment system.

In one embodiment of the method according to the invention, the stored audio data is transmitted from the home entertainment system to the motor vehicle information and entertainment system. The transmission can be effected at least in part via a wired connection, particularly a LAN connection. In addition or as an alternative, the transmission can be effected at least in part via a radio link, particularly a WLAN connection. This means that it is a simple matter to span even relatively great distances between the home entertainment system and the motor vehicle information and entertainment system. Preferably, the stored audio data are transmitted in encrypted form or a connection is set up via a secure channel.

In addition, error recognition preferably takes place during the transmission of the stored audio data for the purpose of error resilience. Furthermore, error correction can be performed. If the error correction is not possible or the capabilities thereof are exhausted, that is to say that further correction of errors is not possible, error concealment preferably takes place in order to conceal errors, this involving erroneous data being replaced by an estimated value.

Preferably, the transmission takes place automatically when a motor vehicle containing the motor vehicle information and entertainment system is started. This advantageously means that the stored audio data are provided for an occupant of the motor vehicle without said occupant having to make a separate request to this end. This can be done by virtue of the motor vehicle information and entertainment system automatically setting up a connection to the home entertainment system, for example via a WLAN connection, when the motor vehicle is started and requesting whether audio data to be transmitted are available. If such audio data are available then they can subsequently be retrieved automatically.

In a further embodiment of the invention, the stored audio data is first transferred from the home entertainment system to a portable storage medium and later transferred from the portable storage medium to the motor vehicle information and entertainment system. Preferably, the stored audio data are transferred from the home entertainment system to the portable storage medium immediately after storage on the at least one storage medium.

The transfer from the home entertainment system to the portable storage medium and/or the transfer from the portable storage medium to the motor vehicle information and entertainment system can take place at least in part via a wired connection and/or via a radio link, particularly a Bluetooth link.

In a further embodiment, the processing and storage apparatus is part of the motor vehicle information and entertainment system.

The received audio and video data can be transmitted from the television reception apparatus to the motor vehicle information and entertainment system. The transmission can be effected at least in part via a wired connection, particularly a LAN connection. In addition or as an alternative, the transmission can be effected at least in part via a radio link, particularly a WLAN connection. This means that it is a simple matter to span even relatively great distances between the television reception apparatus and the motor vehicle information and entertainment system. Preferably, the received audio and video data are transmitted in encrypted form or a connection is set up via a protected channel.

In addition, error recognition preferably takes place during the transmission of the received audio and video data for the purpose of error resilience. Furthermore, error correction can be performed. If the error correction is not possible or the capabilities thereof are exhausted, that is to say that further correction of errors is not possible, error concealment preferably takes place in order to conceal errors, this involving erroneous data being replaced by an estimated value.

In a further refinement of the method according to the invention, the time at which reception of the audio and video data starts and the time at which reception of the audio and video data ends are stipulated before the audio and video data are received and the received audio and video data are transmitted to the processing and storage apparatus completely. This refinement of the method is particularly suitable when a television broadcast is intended to be followed completely by listening to the extracted audio data during a journey in the motor vehicle. This is advantageous particularly in the case of relatively short television programs.

In one alternative refinement of the method according to the invention, the transmission of at least portions of the received audio and video data is started by a first operation of a button during the reception of the audio and video data. In addition, the time at which the transmission ends can be stipulated by the first operation of the button or by at least one second instance of operation of the button. This refinement of the method is particularly advantageous for following a partially viewed television broadcast through to the end.

In a further alternative refinement of the method according to the invention, the reception of the audio and video data is started by a first operation of a button and the received audio and video data is transmitted to the processing and storage apparatus completely. This refinement of the method is particularly advantageous for following a partially viewed television broadcast through to the end if the motor vehicle information and entertainment system has a dedicated television reception apparatus. In this case, the audio and video data can be received by this television reception apparatus, and the further steps of the method according to the invention can likewise be performed by the motor vehicle information and entertainment system.

With particular preference, the button in the cited refinements is part of an ignition key for a motor vehicle containing the motor vehicle information and entertainment system. The method can advantageously resort to already available components of a motor vehicle. In addition, the integration of the button into the ignition key of the motor vehicle allows operation which is as simple and safe as possible. This increases user convenience.

In a further embodiment, the motor vehicle information and entertainment system is in a power-saving mode before at least portions of the received audio and video data are transmitted and is activated, particularly reactivated, by the first operation of the button. This embodiment has the advantage of the lowest possible power consumption by the motor vehicle information and entertainment system, which is of particular significance particularly when the engine of the motor vehicle is switched off.

In a further embodiment of the method according to the invention, at least portions of the received audio and video data is transmitted from the television reception apparatus to a home entertainment system and are stored on a storage medium of the home entertainment system. The stored audio and video data are transferred from the storage medium of the home entertainment system to a portable storage medium first of all and are later transferred from the portable storage medium to the processing and storage apparatus. Preferably, the stored audio and video data are transferred from the storage medium of the home entertainment system to the portable storage medium immediately after storage.

In this case, the transfer from the storage medium of the home entertainment system to the portable storage medium and/or the transfer from the portable storage medium to the processing and storage apparatus can take place at least in part via a wired connection and/or via a radio link, particularly via a Bluetooth link.

In one refinement, the time at which the transmission of at least portions of the received audio and video data to the home entertainment system starts and the time at which the transmission of at least portions of the received audio and video data to the home entertainment system ends are stipulated before the audio and video data are received, and the received audio and video data are transmitted to the home entertainment system completely. This refinement of the method is particularly suitable when a television broadcast is intended to be followed completely by listening to the extracted audio data during a journey in the motor vehicle. This is advantageous particularly in the case of relatively short television programs.

In one alternative refinement, the transmission to the home entertainment system is started by a first operation of a button during the reception of the audio and video data. This refinement of the method is particularly advantageous for following a partially viewed television broadcast through to the end.

In a further embodiment of the method according to the invention, following storage of the extracted audio data, the processing and storage apparatus automatically changes to a power-saving mode, particularly preferably immediately after the storage or immediately after the transfer of the stored audio data to the portable storage medium. This advantageously reduces the power requirement.

The extracted audio data can be compressed before or during the storage. This advantageously results in the lowest possible memory requirement for storing the extracted audio data.

The television reception apparatus is preferably selected from the group comprising a UHF/VHF tuner, a DVB-T tuner, a DVB-C tuner and a DVB-S tuner.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

The invention will now be explained in more detail with reference to the appended figures.

FIG. 1 is a flowchart for storing and transmitting audio data in an audio and video data stream in accordance with a first embodiment of the invention;

FIG. 2 is a flowchart for storing and transmitting audio data in an audio and video data stream in accordance with a second embodiment of the invention;

FIG. 3 is a system for a method for storing and transmitting audio data in an audio and video data stream in accordance with a third embodiment of the invention;

FIG. 4 is a system for a method for storing and transmitting audio data in an audio and video data stream in accordance with a fourth embodiment of the invention;

FIG. 5 is a system for a method for storing and transmitting audio data in an audio and video data stream in accordance with a fifth embodiment of the invention;

FIG. 6 is a system for a method for storing and transmitting audio data in an audio and video data stream in accordance with a sixth embodiment of the invention;

FIG. 7 is a system for a method for storing and transmitting audio data in an audio and video data stream in accordance with a seventh embodiment of the invention; and

FIG. 8 is a system for a method for storing and transmitting audio data in an audio and video data stream in accordance with an eighth embodiment of the invention.

### DETAILED DESCRIPTION OF THE PRESENTLY PREFERRED EMBODIMENTS

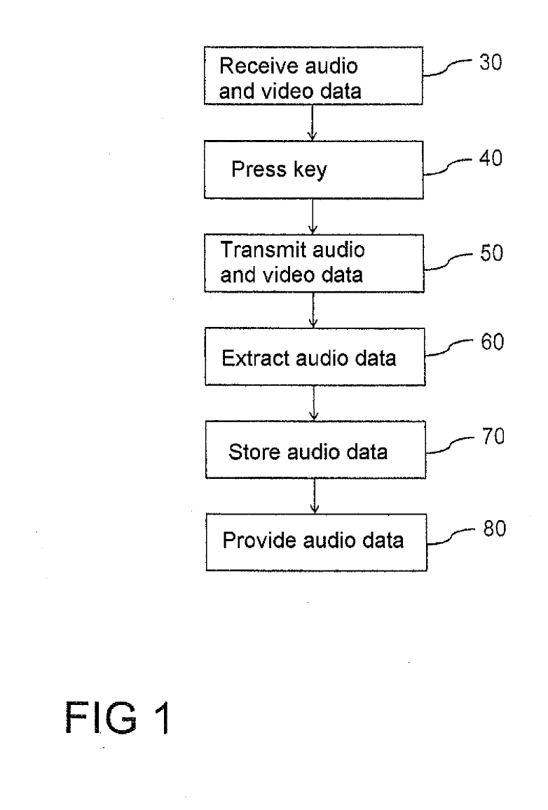

FIG. 1 is a flowchart for a method for storing and transmitting audio data in an audio and video data stream in accordance with a first embodiment of the invention.

To this end, a step 30 involves audio and video data being received by a first television reception apparatus in the form of a television tuner or TV tuner. In this case, the television reception apparatus is associated with a television set, which means that a television viewer can follow an appropriate television program containing the received audio and video data using the television set. It may now occur that the television viewer becomes tired in the course of the broadcast and wants to go to bed or, by way of example, is prevented from following the broadcast further by a telephone call. In order to allow the television viewer in these situations to follow a broadcast which has started through to the end as soon and conveniently as possible, the television viewer pushes a button in a step 40, said button being denoted, by way of example, by an expression such as “Hear you later” or a symbol which denotes audio data, for example a stylized ear. From this time onward, at least the audio portion of the remaining broadcast is recorded.

In the embodiment shown, this is done by virtue of a step 50 involving the audio and video data received by the first television reception apparatus being transmitted to a processing and storage apparatus when the button has been pushed. In a step 60, the audio data is extracted from the transmitted audio and video data by the processing and storage apparatus, and a step 70 involves the extracted audio data being stored on at least one storage medium of the processing and storage apparatus.

Finally, a step 80 involves the stored audio data being provided in at least one motor vehicle information and entertainment system.

The stored audio data are therefore available in the motor vehicle information and entertainment system, which is also called a motor vehicle infotainment and entertainment system, and the viewer can follow the broadcast through to the end soon and conveniently in his own motor vehicle, for example on the way to work the next morning.

In the embodiment shown, the information which is available during reception on the receiving appliance, i.e. on the television reception apparatus, in the form of an audio and video data stream is therefore converted into a data stream in another format, which is less memory intensive than the original data format, and said data stream is made available on a different appliance than the originally receiving appliance without being reliant on external sources in order to do so. This dispenses with the need particularly to search for and download audio podcasts from the Internet, these being provided by some television broadcasters for selected broadcasts.

In addition, the embodiment shown is particularly convenient because it is merely necessary to push the button. Furthermore, the embodiment shown has a low memory space requirement, since no extensive video data are stored which cannot or must not be used in the motor vehicle, particularly by the driver of the motor vehicle.

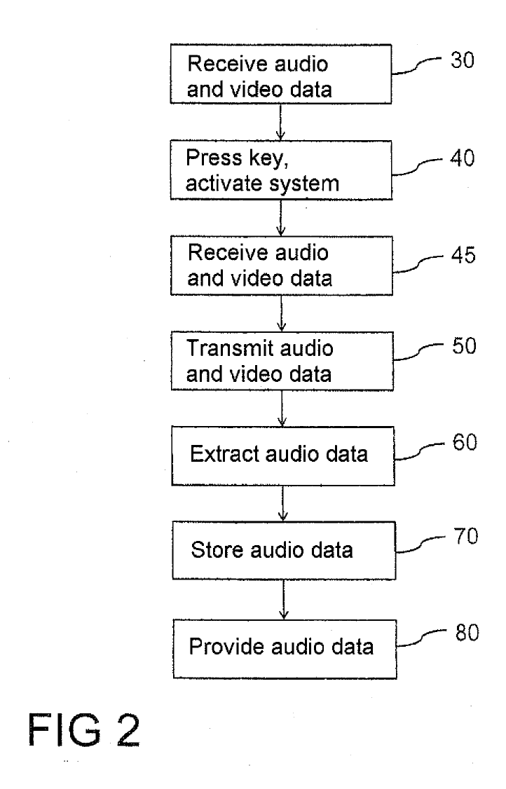

FIG. 2 shows a flowchart for a method for storing and transmitting audio data in an audio and video data stream in accordance with a second embodiment of the invention. Components having the same functions as in FIG. 1 are denoted by the same reference symbols and are not discussed in more detail below.

In the second embodiment of the method according to the invention, a step 30 involves audio and video data being received by a second television reception apparatus in the form of a television tuner or TV tuner. In this case, the second television reception apparatus is associated with a television set, which means that a television viewer can follow a television program containing the received audio and video data using the television set.

In a step 40, a button is pushed, which records at least the audio portion of the remaining broadcast.

In the embodiment shown, this is done by virtue of the pushing of the button activating a motor vehicle information and entertainment system which was previously preferably in a power-saving mode, and said motor vehicle information and entertainment system either using a direct connection to the second television reception apparatus or using a connection to a home entertainment system which is connected to the second television reception apparatus to check which channel is currently selected on the second television reception apparatus. Next, in a step 45, audio and video data are received by a first television reception apparatus, the latter being associated with the motor vehicle information and entertainment system, and the same channel having been selected on the first television reception apparatus as has also been selected on the second television reception apparatus.

In a step 50, the audio and video data received from the first television reception apparatus are transmitted to a processing and storage apparatus, which in the embodiment shown is likewise part of the motor vehicle information and entertainment system.

In a step 60, the audio data is extracted from the transmitted audio and video data by means of the processing and storage apparatus, and a step 70 involves the extracted audio data being stored on at least one storage medium of the processing and storage apparatus.

Finally, in a step 80, the stored audio data are provided in the motor vehicle information and entertainment system.

This embodiment of the method is particularly advantageous for following a partially viewed television broadcast through to the end if the motor vehicle information and entertainment system has a dedicated television reception apparatus, since the audio and video data can be received by the television reception apparatus.

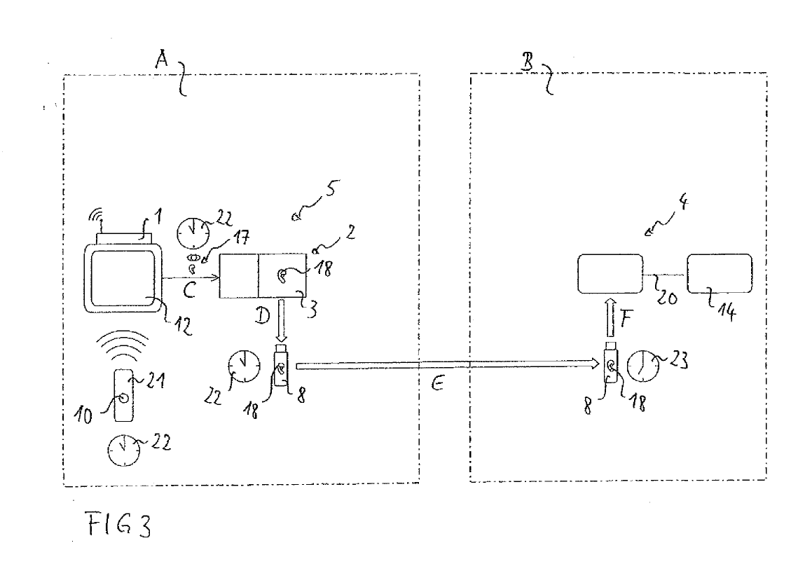

FIG. 3 is system for a method for storing and transmitting audio data in an audio and video stream in accordance with a third embodiment of the invention.

In this case, audio and video data is received by a television reception apparatus 1. In this context, the television reception apparatus 1 has been selected from the group comprising a UHF/VHF tuner, a DVB-T tuner, a DVB-C tuner and a DVB-S tuner, for example.

The television reception apparatus 1 is associated with a television set 12, which means that a television viewer—not shown in FIG. 3—can follow the received audio and video data on the television set 12.

If the television viewer now becomes tired in the course of the broadcast and wants to go to bed, but nevertheless wishes to follow the interrupted broadcast through to the end as soon and conveniently as possible, the viewer operates a button 10 on a remote control 21, as a result of which the schematically shown audio and video data 17 is transmitted to a processing and storage apparatus 2 from this time onward. This is shown schematically by an arrow C. In the processing and storage apparatus 2, the schematically shown audio data 18 is extracted from the transmitted audio and video data 17 and is stored on a storage medium 3 of the processing and storage apparatus 2. By way of example, this can be done by converting the sound track into a possibly compressed audio data stream and storing the audio data stream or the compressed audio data stream.

In this case, the time at which the transmission of the received audio and video data 17 to the processing and storage apparatus 2 ends can be stipulated by the first operation or by at least one second instance of operation of the button 10. The first operation of the button 10 transmits the received audio and video data to the processing and storage apparatus 2 and hence records or stores the audio data 18 for 30 minutes, for example. Should this time be insufficient to record the remainder of the broadcast in the form of the audio data 18, operating the button 10 further times allows the transmission period and hence the recording or storage period to be increased in steps. By way of example, each further instance of operation after the first can be an increase of 30 minutes. Alternatively, it is possible for further data, which particularly contain the time at which the television broadcast ends, to be received in addition to the audio and video data 17 and for said data likewise to be transmitted to the processing and storage apparatus 2, which takes them and determines the time at which the television broadcast ends and hence the time at which the transmission ends.

In the embodiment shown, the processing and storage apparatus 2 is part of a home entertainment system 5. The television reception apparatus 1, the television set 12 and the home entertainment system 5 are arranged in an area A, which schematically represents an apartment or a house.

In this case, the audio data 18 is extracted from the transmitted audio and video data 17, and the extracted audio data 18 is stored on the storage medium 3, on the very same evening on which the audio and video data 17 are also received by of the television reception apparatus 1 and on which the received audio and video data 17 are almost simultaneously transmitted to the processing and storage apparatus 2 after the button 10 is first operated, which is shown schematically by a clock 22. In addition, the stored audio data 18 are transferred from the storage medium 3 of the processing and storage apparatus 2 to a portable storage medium 8 on the very same evening immediately after the storage of the extracted audio data 18 on the storage medium 3 has ended. This is shown schematically by an arrow D. By way of example, the portable storage medium 8 is a USB memory stick. In this context, the stored audio data 18 can be transferred to the portable storage medium 8 by wire or wirelessly, particularly via a Bluetooth link. Preferably, the processing and storage apparatus 2 automatically changes to a power-saving mode immediately after the stored audio data 18 has been transferred to the portable storage medium 8. In particular, it can switch itself off completely.

Next morning, which is shown schematically by a clock 23, the portable storage medium 8 is transferred into an area B which schematically represents a motor vehicle, as shown by an arrow E.

Next, the stored audio data 18 is transferred from the portable storage medium 8 to a motor vehicle information and entertainment system 4 in the motor vehicle. This is shown schematically by an arrow F. As a result, the stored audio data 18 is provided for the motor vehicle information and entertainment system 4. The interrupted broadcast can therefore be followed through to the end during a journey in the motor vehicle by virtue of the stored audio data 18 being played back via a loudspeaker system 14, which is connected to the motor vehicle information and entertainment system 4 via a connecting line 20.

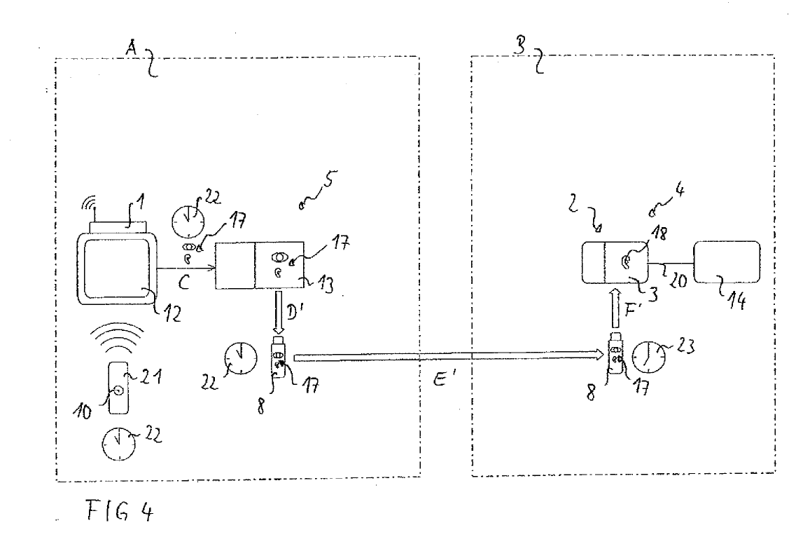

FIG. 4 is a system for a method for storing and transmitting audio data in an audio and video data stream in accordance with a fourth embodiment of the invention. Components having the same functions as in FIG. 3 are denoted by the same reference symbols and are not discussed in more detail below.

The fourth embodiment differs from the third embodiment in that the processing and storage apparatus 2 is part of the motor vehicle information and entertainment system 4. When the button 10 has been operated, the received audio and video data 17 is transmitted from the television reception apparatus 1 to the home entertainment system 5 and is stored on a storage medium 13 of the home entertainment system 5. The stored audio and video data 17 is transferred from the storage medium 13 of the home entertainment system 5 to the portable storage medium 8 on the same evening immediately after the storage has ended. This is shown schematically by an arrow D′. Preferably, the home entertainment system 5 automatically changes to a power-saving mode immediately after the stored audio and video data 17 has been transferred to the portable storage medium 8. In particular, it can switch itself off completely.

The next morning, the portable storage medium 8 is transferred to the motor vehicle, as shown schematically by an arrow E′. The stored audio and video data 17 are then transferred from the portable storage medium 8 to the processing and storage apparatus 2. This is shown schematically by an arrow F′. Next, the audio data 18 is extracted from the transferred audio and video data 17 by the processing and storage apparatus 2 and are stored on a storage medium 3 of the processing and storage apparatus 2.

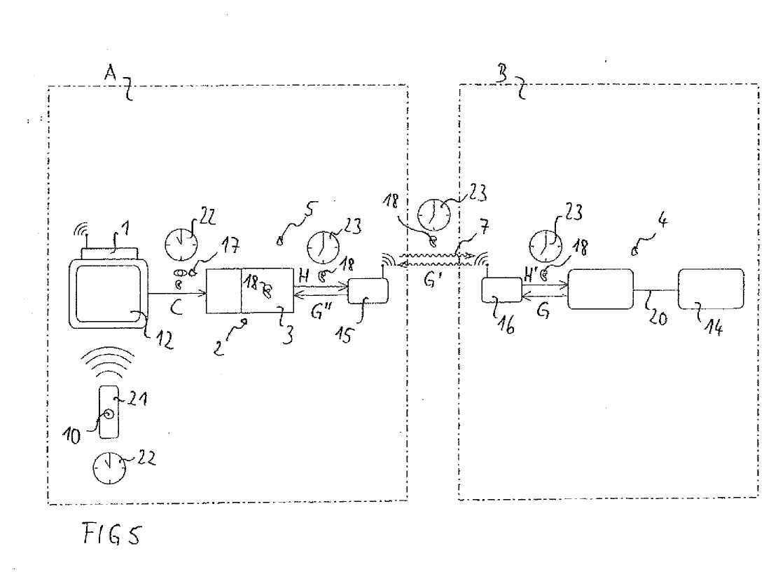

FIG. 5 is a system for a method for storing and transmitting audio data in an audio and video data stream in accordance with a fifth embodiment of the invention. Components having the same functions as in the preceding figures are denoted by the same reference symbols and are not discussed in more detail below.

In the embodiment shown, the processing and storage apparatus 2 is part of a home entertainment system 5. The embodiment shown differs from the embodiment shown in FIG. 3 in that the stored audio data 18 is transmitted from the home entertainment system 5 to the motor vehicle information and entertainment system 4 automatically when the motor vehicle is started.

To this end, when the motor vehicle is started, the motor vehicle information and entertainment system 4 autonomously checks whether there is data to be transferred on the storage medium 3 of the processing and storage apparatus 2. In the embodiment shown, the check is transmitted from the motor vehicle information and entertainment system 4 to a transmission and reception apparatus 16 associated with the motor vehicle. This is shown schematically by an arrow G. The transmission and reception apparatus 16 forwards the check to a transmission and reception apparatus 15 arranged in the area A. This is shown schematically by an arrow G′. Said transmission and reception apparatus 15 finally forwards the check to the processing and storage apparatus 2. This is shown schematically by an arrow G″.

If the storage medium 3 contains stored audio data 18, said audio data 18 is transferred to the transmission and reception apparatus 15. This is shown schematically by an arrow H. The transmission and reception apparatus 15 transmits the audio data 18 via a radio link 7, for example a WLAN connection, to the transmission and reception apparatus 16 associated with the motor vehicle. The transmission and reception apparatus 16 transmits the audio data 18 to the motor vehicle information and entertainment system 4, as shown schematically by an arrow H′.

As a result, the stored audio data 18 can be provided in the motor vehicle information and entertainment system 4 in a particularly convenient manner without this requiring a portable storage medium. In addition, the motor vehicle information and entertainment system 4 is not activated until the motor vehicle is started, which means that the motor vehicle information and entertainment system 4 does not require a quiescent mode and hence also does not require reactivation during the quiescent mode in order to provide the stored audio data 18 in the motor vehicle information and entertainment system 4.

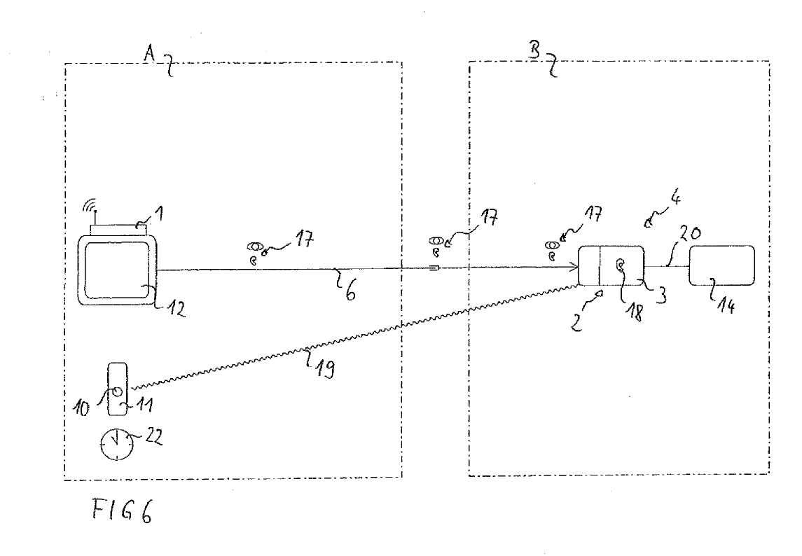

FIG. 6 is a system for a method for storing and transmitting audio data in an audio and video data stream in accordance with a sixth embodiment of the invention. Components having the same functions as in the preceding figures are denoted by the same reference symbols and are not discussed in more detail below.

In the embodiment shown, the processing and storage apparatus 2 is part of the motor vehicle information and entertainment system 4. This embodiment differs from the embodiment shown in FIG. 4 in that the audio and video data are transmitted to the processing and storage apparatus 2 on the very same evening on which the television broadcast is received. To this end, first operation of the button 10 is used not only to start the transmission of the received audio and video data but also to activate the motor vehicle information and entertainment system 4, which was preferably in a power-saving mode or quiescent mode before the transmission of the received audio and video data. The motor vehicle information and entertainment system 4 is therefore “awoken” by the first operation of the button 10.

In the embodiment shown, the button 10 is preferably part of an ignition key 11 for the motor vehicle, said ignition key 11 being operatively connected to the motor vehicle information and entertainment system 4 via a radio link 19. This advantageously allows the method to resort to components of the motor vehicle which are already available and which are modified as appropriate. In addition, the integration of the button 10 into the ignition key 11 of the motor vehicle allows the simplest and safest operation possible.

In the embodiment shown, the audio and video data 17 is transmitted from the television reception apparatus 1 to the motor vehicle information and entertainment system 4 via a wired connection 6. In the processing and storage apparatus 2, the audio data 18 are then extracted from the transmitted audio and video data 17 and is stored on a storage medium 3 of the processing and storage apparatus 2.

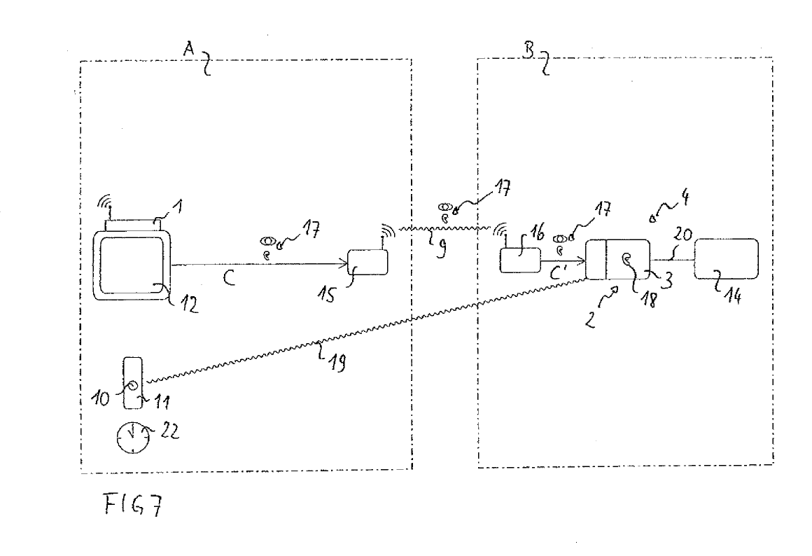

FIG. 7 is a system for a method for storing and transmitting audio data in an audio and video data stream in accordance with a seventh embodiment of the invention. Components having the same functions as in the preceding figures are denoted by the same reference symbols and are not discussed in more detail below.

This embodiment differs from the embodiment shown in FIG. 6 in that the received audio and video data 17 is transmitted from the television reception apparatus 1 to the motor vehicle information and entertainment system 4 at least partially via a radio link 9. To this end, the received audio and video data 17 is transmitted to a transmission and reception apparatus 15 arranged in the area A, as shown schematically by an arrow C. The transmission and reception apparatus 15 transmits the audio and video data 17 via the radio link 9 to a transmission and reception apparatus 16 associated with the motor vehicle. Next, the audio and video data 17 is transmitted from the transmission and reception apparatus 16 to the processing and storage apparatus 2, as shown schematically by an arrow C′.

The audio data 18 is extracted from the transmitted audio and video data 17 by the processing and storage apparatus 2 and is stored on a storage medium 3 of the processing and storage apparatus 2.

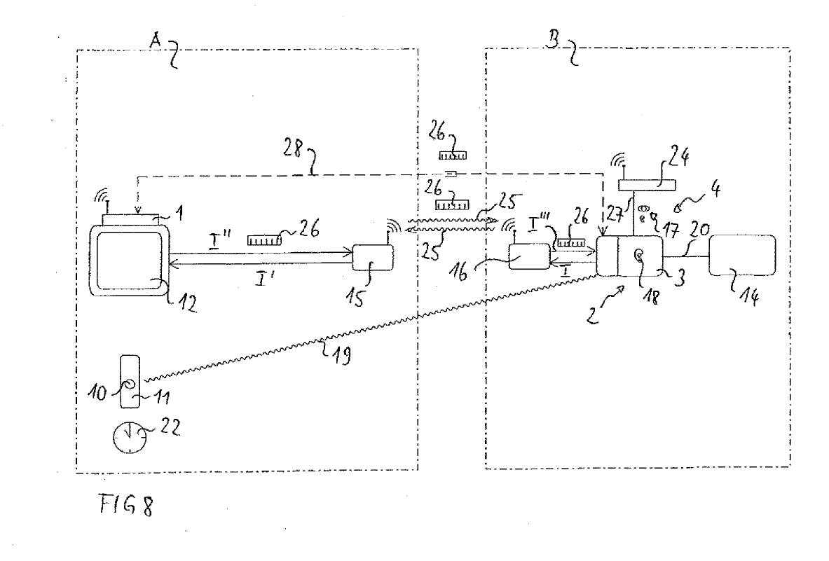

FIG. 8 is a system for a method for storing and transmitting audio data in an audio and video data stream in accordance with an eighth embodiment of the invention. Components having the same functions as in the preceding figures are denoted by the same reference symbols and are not discussed in more detail below.

This embodiment differs from the embodiments shown in FIGS. 3 to 7 in that the motor vehicle contains a television reception apparatus 24 which, in the embodiment shown, is connected to the motor vehicle information and entertainment system 4 by a connecting line 27 or can be integrated into the motor vehicle information and entertainment system 4, in which case the connecting line 27 runs inside the motor vehicle information and entertainment system 4. In this case, the television reception apparatus 24 has been selected from the group comprising a UHF/VHF tuner, a DVB-T tuner and a DVB-S tuner, for example.

As in the preceding embodiments, the embodiment shown in FIG. 8 also involves audio and video data being received by the television reception apparatus 1 associated with the television set 12, which means that a television viewer—not shown in FIG. 8—can follow the received audio and video data on the television set 12.

If the television viewer now becomes tired in the course of the broadcast and wants to go to bed, but nevertheless wishes to follow the interrupted broadcast through to the end as soon and conveniently as possible, the viewer operates the button 10 on the ignition key 11, which is operatively connected to the motor vehicle information and entertainment system 4 via a radio link 19, as a result of which the motor vehicle information and entertainment system 4, which was preferably previously in a power-saving mode or quiescent mode, is activated.

Next, the motor vehicle information and entertainment system 4 autonomously checks which channel is currently selected on the television reception apparatus 1. In the embodiment shown, the check is in this case transmitted from the motor vehicle information and entertainment system 4 to a transmission and reception apparatus 16 associated with the motor vehicle. This is shown schematically by an arrow I. The transmission and reception apparatus 16 forwards the check via a radio link 25 to a transmission and reception apparatus 15 arranged in the area A. Said transmission and reception apparatus 15 finally forwards the check to the television reception apparatus 1. This is shown schematically by an arrow I. Schematically shown information 26 about which channel is currently selected on the television reception apparatus 1 is then routed from the television reception apparatus 1 to the transmission and reception apparatus 15. This is shown schematically by an arrow I″. The transmission and reception apparatus 15 forwards the information data 26 to the transmission and reception apparatus 16 via the radio link 25. Said transmission and reception apparatus 16 forwards the information data 26 to the motor vehicle information and entertainment system 4. This is shown schematically by an arrow I′. The motor vehicle information and entertainment system 4 then sets the television reception apparatus 24 to the same channel as has also been selected on the television reception apparatus 1.

Next, the connecting line 27 is used to transmit the schematically shown audio and video data 17 to the processing and storage apparatus 2, which is part of the motor vehicle information and entertainment system 4. In the processing and storage apparatus 2, the schematically shown audio data 18 are extracted from the transmitted audio and video data 17 and are stored on a storage medium 3 of the processing and storage apparatus 2.

The check and the information data 26 represent a relatively small volume of data. This communication channel therefore requires only a very low bandwidth or a low throughput. It may therefore be possible to dispense with a WLAN connection and to use an alternative wireless method with a lower bandwidth, which has a lower power requirement, for example ZigBee.

As an alternative to the illustrated checking and transmission of the information data 26 at least partially via the radio link 25, the information data 26 can be checked and transmitted via a wired connection 28, shown in dashes.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A method for storing and transmitting audio data in an audio and video data stream, comprising:
receiving the audio and video data by a television reception apparatus;
transmitting at least a portion of the received audio and video data to a processing and storage apparatus;
extracting the audio data are from the transmitted audio and video data by the processing and storage apparatus;
storing the extracted audio data on at least one storage medium of the processing and storage apparatus; and
providing the stored audio data to at least one motor vehicle information and entertainment system.

2. The method as claimed in claim 1, wherein the processing and storage apparatus is part of a home entertainment system.

3. The method as claimed in claim 2, further comprising transmitting the stored audio data from the home entertainment system to the motor vehicle information and entertainment system.

4. The method as claimed in claim 3, wherein the transmission takes place automatically when a motor vehicle containing the motor vehicle information and entertainment system is started.

5. The method as claimed in claim 2, further comprising:
transferring the stored audio data is from the home entertainment system to a portable storage medium; and
transferring the stored audio data from the portable storage medium to the motor vehicle information and entertainment system.

6. The method as claimed in claim 1, wherein the processing and storage apparatus is part of the motor vehicle information and entertainment system.

7. The method as claimed in claim 6, wherein the received audio and video data are transmitted from the television reception apparatus to the motor vehicle information and entertainment system.

8. The method as claimed in claim 1, wherein a time at which reception of the audio and video data starts and a time at which reception of the audio and video data ends are stipulated before the audio and video data are received and wherein the received audio and video data are transmitted to the processing and storage apparatus.

9. The method as claimed in claim 1, wherein the transmission of at least part of the received audio and video data is started by a first operation of a button during the reception of the audio and video data.

10. The method as claimed in claim 9, wherein the time at which the transmission ends is stipulated by at least one of the first operation of the button and at least one second instance of operation of the button.

11. The method as claimed in claim 1, wherein the reception of the audio and video data is started by a first operation of a button and wherein the received audio and video data is transmitted to the processing and storage apparatus.

12. The method as claimed in claim 9, wherein the button is part of an ignition key for a motor vehicle containing the motor vehicle information and entertainment system.

13. The method as claimed in claim 9, wherein the motor vehicle information and entertainment system is in a power-saving mode before at least portions of the received audio and video data is transmitted and the motor vehicle information and entertainment system is activated by the first operation of the button.

14. The method as claimed in claim 6, further comprising:
transmitting at least portions of the received audio and video data are from the television reception apparatus to a home entertainment system;
storing the at least portions of the received audio and video data on a storage medium of the home entertainment system;
transferring the stored audio and video data from the storage medium of the home entertainment system to a portable storage medium; and
transferring the stored audio and video data from the portable storage medium to the processing and storage apparatus.

15. The method as claimed in claim 1, wherein the television reception apparatus is selected from the group comprising a UHF/VHF tuner, a DVB-T tuner, a DVB-C tuner, and a DVB-S tuner.

16. The method as claimed in claim 3, further comprising:
performing error recognition during the transmission of the received audio and video data.

17. The method as claimed in claim 16, further comprising:
performing error concealment to conceal errors by replacing erroneous data by estimated data.

18. The method as claimed in claim 9, wherein each button activation corresponds to storing a half hour of the received audio and video data.
